(19) United States
(12) Patent Application Publication
(10) Pub. No.: US 2022/0386062 A1
(43) Pub. Date: Dec. 1, 2022

(54) STEREOPHONIC AUDIO REARRANGEMENT BASED ON DECOMPOSED TRACKS

(71) Applicant: Algoriddim GmbH, Munich (DE)

(72) Inventor: Kariem Morsy, Munich (DE)

(21) Appl. No.: 17/334,352

(22) Filed: May 28, 2021

(51) Int. Cl. H04S 7/00; H04S 1/00; G06F 3/16; G10L 21/028; G10L 25/30; G06N 3/02

(52) U.S. Cl. CPC H04S 7/303; H04S 1/007; H04S 1/002; G06F 3/165; G10L 21/028; G10L 25/30; G06N 3/02; H04S 2400/11; H04S 2420/01

(57) ABSTRACT

The present invention provides a method for processing audio data, comprising providing input audio data containing a mixture of different timbres, decomposing the input audio data to generate decomposed data representing a predetermined timbre selected from the timbres contained in the input audio data, determining a set point position of a virtual sound source outputting the predetermined timbre relative to a position of a virtual listener, and generating stereophonic output data based on the decomposed data and the determined set point position.

The present invention relates to a method for processing audio data including the steps of providing input audio data and generating stereophonic output data. Further, the present invention relates to a device for processing audio data, comprising an input unit receiving input audio data and a stereophonic audio unit for generating stereophonic output data, as well as to a computer program for processing audio data.

Nowadays, a major part of audio material is recorded, processed and played back in the form of stereophonic sound, including two-channel, multi-channel and surround sound. Stereophonic sound creates an illusion of one or more sound sources distributed in a virtual 3D space around a listener. For example, during music production, an audio engineer usually mixes a number of different instruments or voices on two or more stereo channels using 3D stereo imaging tools or filters in such a way that, when the music is played back through stereophonic headphones or via two or more other loudspeakers, a listener will hear the music under the impression that the sound of different sound sources is coming from different directions, respectively, comparable to natural hearing. For example, the listener will hear the various instruments contributing to a piece of music as coming from different directions as if they would actually be present in front of or around the listener. As another example, live concerts or other live audio sources are recorded using stereo microphones in order to capture the 3D acoustic information and reproduce it at a later point in time via playback of stereophonic output data.

In mixed audio data, such as commercial music audio files distributed through streaming providers or online music stores, the stereo image is usually predetermined according to the arrangement of the individual instruments or sound sources defined by the sound engineer at the time of producing the audio file. Furthermore, some recordings are even monophonic and do not have any spatial information at all. Although there are several attempts known in the prior art to manipulate the stereo image of mixed audio files or even create a stereo image for original monophonic recordings, the capabilities of such pseudo-stereo algorithms are quite limited. For example, the stereo imager as distributed by Multitrack Studio (www.multitrackstudio.com/pseudostereo.php) may increase the overall width of a stereo recording to generate an impression of a larger audio source instead of the sound coming from a single point in space. However, a true stereo experience allowing localization of different sound sources within the space around the listener is not possible with this approach.

It was therefore an object of the present invention to provide a method, a device and a computer program for processing audio data and generating stereophonic output data, which allow creating or changing a true stereophonic sound including rearranging at least one sound source in the virtual 3D space, based on mixed audio data.

According to a first aspect of the invention, this object is achieved by a method for processing audio data, comprising providing input audio data containing a mixture of different timbres, decomposing the input audio data to generate decomposed data representing a predetermined timbre selected from the timbres contained in the input audio data, determining a set point position of a virtual sound source outputting the predetermined timbre relative to a position of a virtual listener, and generating stereophonic output data based on the decomposed data and the determined set point position.

According to an important feature of the present invention, the input audio data are decomposed such as to extract at least one timbre and to generate decomposed data that includes the extracted timbre. The predetermined timbre is therefore separated from the remaining components of the sound and is provided as decomposed data. The idea behind this concept is to separate the sound of a virtual sound source such as an instrument included in the mixed audio data, and to place the separated sound source at a desired position within the stereo image according to a set point position. Stereophonic output data can then be generated, which include localization information according to the desired set point position of the sound source such that the stereophonic output data, when reproduced by stereo headphones or two or more stereo loudspeakers, generate an impression that the specified sound source is located at the set point position in the virtual 3D space around the listener.

In the context of the present disclosure, the term “stereophonic” refers to any type of spatial sound, i.e. sound that seems to surround the listener and to come from more than one source, including two-channel, multi-channel and surround sound. Furthermore, in the context of the present invention, headphones are understood as including a pair of left and right loudspeakers. Headphones and/or loudspeaker include wireless devices (Bluetooth devices) as well as devices connect via audio cables.

It should further be noted that, in the context of the present disclosure, decomposing the input audio data refers to separating or isolating specific timbres from other timbres, which in the original input audio data were mixed in parallel, i.e. overlapped on the time axis, such as to be played together within the same time interval. Likewise, it should be noted that mixing or recombining of audio data or tracks refers to overlapping in parallel, summing, downmixing or simultaneously playing/combining corresponding time intervals of the audio data or tracks, i.e. without significantly shifting the audio data or tracks relative to one another with respect to the time axis.

Furthermore, in the context of the present disclosure, input audio data containing a mixture of different timbres are representative of audio signals obtained from mixing a plurality of source tracks, for example during music production or during recording of a live musical performance of instrumentalists and/or vocalists. Thus, input audio data may usually originate from a previous mixing process that has been completed before the start of the processing of audio data according to the present invention. In particular, the input audio data may be provided as audio files together with meta data, for example in audio files containing a piece of music that has been produced in a recording studio by mixing a plurality of source tracks of different timbres. For example, a first source track may be a vocal track (vocal timbre) obtained from recording a vocalist via a microphone, while a second source track may be an instrumental track (instrumental timbre) obtained from recording an instrumentalist via a microphone or via a direct line signal from the instrument or via MIDI through a virtual instrument. Usually, a plurality of such tracks are recorded at the same time or one after another. The plurality of source tracks are then transferred to a mixing station, wherein the source tracks are individually edited, various audio effects and individual volume levels are applied to the source tracks, all source tracks are mixed in parallel, and preferably one or more mastering effects are eventually applied to the sum of all tracks. At the end of the production process, the final audio mix, usually a stereo mix, is stored in a suitable recording medium, for example in an audio file on the hard drive of a computer. Such audio files preferably have a conventional compressed or uncompressed audio file format, such as MP3, WAV, AIFF or other, in order to be readable by standard playback devices, such as computers, tablets, smartphones or DJ devices. For processing according to the present invention, the input audio data may then be provided as audio files by reading the files from local storage means, receiving the audio files from a remote server, for example via streaming through the Internet, or in any other manner.

Thus, input audio data include a mixture of audio data of different timbres, wherein the timbres originate from different sound sources, such as different musical instruments, different software instruments or samples, different voices, noises, sound FX etc. In particular, a certain timbre may refer to at least one of:
a recorded sound of a certain musical instrument (such as a bass, piano, drums (including classical drum set sounds, electronic drum set sounds, percussion sounds), guitar, flute, organ etc.) or any group of such instruments;
a synthesizer sound that has been synthesized by an analog or digital synthesizer, for example to resemble the sound of a certain musical instrument (such as a bass, piano, drums (including classical drum set sounds, electronic drum set sounds, percussion sounds), guitar, flute, organ etc.) or any group of such instruments;
a sound of a vocalist (such as a singing or rapping vocalist) or a group of vocalists;
a noise source;
any combination thereof.

These timbres relate to specific frequency components and distributions of frequency components within the spectrum of the audio data as well as temporal distributions of frequency components within the audio data, and they may be separated through an AI system specifically trained with training data containing these timbres, as will be explained in more detail later.

In a preferred embodiment, the input audio data represents a piece of music that contains a mixture of musical timbres. The musical timbres may represent different musical instruments or different vocal components of the piece of music. When decomposing the input audio data, a set of decomposed data may be generated, which represents one particular musical timbre from among the musical timbres of the piece of music, e.g. one particular musical instrument. In an embodiment, two or more sets of decomposed data each representing individual musical timbres selected from the predetermined musical timbres of the piece of music may be generated in the step of decomposing the input audio data. In such an embodiment, a set point position may be associated to the virtual sound source outputting the particular musical timbre (e.g. instrument) represented by the decomposed data. More preferably, a plurality of set point positions may be determined, wherein an individual set point position is determined for each of the virtual sound sources, e.g. for each of the musical instruments. The stereophonic output data may then be generated based on the decomposed data and the at least one set point position such as to generate stereophonic output data in which the particular sound source is virtually placed according to its desired set point position.

In other words, the input audio data may represent a piece of music containing a mixture of at least a first musical timbre and a second musical timbre, wherein decomposing the input audio data generates first decomposed data representing only the first musical timbre and second decomposed data representing only the second timbre, wherein the method comprises determining a first set point position of a first virtual sound source outputting the first musical timbre relative to a position of the virtual listener, and determining a second set point position of a second virtual sound source outputting the second musical timbre relative to a position of the virtual listener, and wherein determining the stereophonic output data is based on the first and second decomposed data and the first and second set point positions.

In this manner a stereophonic sound may be generated in which the individual musical instruments are placed at their respective associated set point positions within the 3D audio space around the listener. In particular, it is possible to change a given stereophonic sound of the input audio data such as to rearrange at least one virtual sound source contained in the input audio data, or to newly create a stereophonic sound from monophonic input audio data.

For the step of generating stereophonic output data based on the decomposed data and the determined set point position, a number of conventional approaches may be used, such as conventional algorithms or software tools that allow positioning a virtual sound source at a desired position in the stereophonic image. For example, placement of an audio source within the stereophonic image can be achieved by introducing an intensity difference and/or a time difference between left and right output channels of the stereophonic output data, such as to mimic the natural hearing of a sound source positioned at a specified set point position. For example, if the sound source is positioned on the right side of the listener, the right ear will perceive the sound of the sound source at an earlier point in time and with a higher intensity than the left ear. In particular, according to a very rough approach, the time delay Δt to be inserted between the audio signals associated to the left and right channels of the stereophonic output data can be calculated by Δt=x·cos θ÷c, wherein x is the distance between the ears, c is the speed of sound and θ is the angle between the baseline of the ears and the incident sound. Thus, by introducing a time delay, and/or an intensity difference, between the audio signals associated to the left and right channels of the stereophonic output data, the perception of a virtual sound source located at a desired set point position can be emulated even if the loudspeakers or headphones are positioned at a constant distance on both sides of the listener.

Besides the two strong cues for estimating the apparent direction of the sound source, intensity difference and time difference between the left and right channels, there are additional cues based on which humans are able to localize a sound source in the 3D space. One of these additional cues is reverberation, since humans tend to locate sound sources having stronger reverberation at positions farther away than other sound sources having less reverberation. The step of generating stereophonic output data may therefore also include adding or reducing reverberation of audio data obtained from the decomposed data based on the determined set point position of the sound source, in particular based on the distance of the determined set point position from the virtual listener.

Another 3D cue is based on the Doppler Effect, which acoustically indicates a relative movement between a sound source and the listener by generating a certain pitch shift of the sound emitted by the sound source depending on the speed of the movement. The step of generating stereophonic output data may therefore also include changing the pitch of the decomposed data depending on a relative movement between the set point position of the virtual sound source and the virtual listener.

In a further embodiment of the invention, the decomposed data may be modified such as to simulate the change of the sound coming from the sound source due to propagation of the sound in a medium different from air, such as in water. The step of generating stereophonic output data may therefore also include applying one or more audio effects, for example an under-water simulating audio effect, to the decomposed data.

Furthermore, it is known to use head-related transfer functions (HRTFs) to mimic the transmission, reflection, diffraction, or any other modification of sound waves by the human body and thus more realistically estimate the sound to be received by the left and right ears, respectively, and configure effects and time delays to be applied to the audio data assigned to the different channels of the stereophonic output data. Therefore, in preferred embodiments of the invention, determining the stereophonic output data may include a spatial effect processing of audio data obtained from the decomposed data, for example an HRTF filter, wherein a parameter of the spatial effect processing is set depending on the determined set point position. In the present disclosure a spatial effect processing is defined as including any filter processing or audio effect processing which modifies an audio signal such as to introduce or change localization information, i.e. acoustic information suitable for providing cues to a listener regarding the position, relative to the listener, of a virtual sound source emitting the audio signal. In particular, spatial effect processing includes HRTF filter processing, reverberation processing, delay processing, panning, volume or intensity modification processing.

Alternatively or in addition, determining the stereophonic output data may include applying time-shift processing to audio data obtained from the decomposed data, wherein the time shift is set depending on the determined set point position. It should be noted that time-shift processing is preferably applied only in a case that the spatial output data are reproduced through headphones, because the time-shift processing could result in undesired delay-like effects if reproduced by loudspeakers placed at a distance from the listener.

In another embodiment of the invention, generating the stereophonic output data may involve using a software library or software interface, such as OpenAL (http://www.openal.org). OpenAL allows generating audio data in a simulated three-dimensional space and provides functions of defining a plurality of sound sources distributed at specified set point positions in the space. The library is then able to calculate stereophonic output data in standard format for reproduction through headphones or multiple loudspeakers. OpenAL includes a number of additional features such as a Doppler Effect algorithm.

Furthermore, there are a number of other stereo imaging plugins or other stereo imaging software applications available on the market, which generate stereophonic output data on the basis of the audio data emitted by a particular sound source and at a desired set point position of that sound source in the 3D space.

In a further embodiment of the present invention, determining the stereophonic output data includes mixing of first audio data obtained from the decomposed data with second audio data different from the first audio data. In this way, the stereophonic output data may not only include the decomposed data, for example a separated single instrument, but may include other sound components, namely the second audio data. In particular, the step of decomposing the input data may generate first decomposed data representing a specified first timbre selected from the plurality of timbres, and second decomposed data representing a specified second timbre selected from the plurality of timbres, wherein the second audio data are obtained from the second decomposed data such as to represent the specified second timbre. Therefore, mixing of the first audio data and the second audio data achieves a recombination of timbres that were separated in the step of decomposing, wherein this recombination takes into account the desired set point position of at least the first virtual sound source outputting the specified first timbre.

In the manner described above, the step of decomposing the input audio data may generate complimentary decomposed data, which means a plurality of sets of decomposed data representing individual timbres such that a mixture of all sets of decomposed data would substantially correspond to the original input audio data. Such complimentary decomposition or complete decomposition allows rearranging the stereophonic image or creating a new stereophonic image without otherwise changing or reducing the audio content of the original input audio data. In this way, for example a piece of music will be reproduced as stereophonic output data, which has substantially equal musical content as the input audio data, except for a rearrangement of the individual positions of the individual instruments or vocal components in the stereophonic image. In other words, the same instruments or sound components as in the original input audio data are playing the same piece of music in the same manner with only the positions of the individual instruments or sound sources in the virtual 3D space being changed.

In order to achieve high quality decomposition results and to generate high quality stereophonic output data, it is advantageous to remove any localization information that may be contained in the original input audio data or in the decomposed data. In particular, it is preferred to reduce or remove reverberation from the input audio data or the decomposed data before the step of generating stereophonic output data. Furthermore, in case of providing input audio data as stereophonic audio data, conversion of the input audio data to monophonic input audio data may be advantageous. In other embodiments, stereophonic input audio data may be decomposed to obtain monophonic decomposed data of high quality, which may then be used to generate stereophonic output data in accordance with the determined set point position of the virtual sound source associated with the decomposed data.

The set point position of the at least one virtual sound source may be determined based on user input. In such an embodiment, a user may control, define or modify the position of the sound source within the virtual 3D space as desired, for example by operating a user input device such as a pointing device, a touchscreen, a midi controller etc. This allows a user to control the arrangement of one or more virtual sound sources within the virtual space, for example to position instruments or vocalists associated to a piece of music at desired positions relative to the listener.

Furthermore, the set point position may be determined by an algorithm. In a simple embodiment, the set point position may be set to a reference value such as to the position of the virtual listener (center position). Starting from this position, the user may then modify the set point position as desired. In another example, the set point position may be set by a random algorithm to a random position within a predetermined region of the virtual 3D space. In a further embodiment, the set point position may be changed dynamically to follow a predetermined trajectory with a predetermined speed, such as to allow, for example, a musical instrument to virtually move around the listener or to move towards or away from the listener with a certain speed. Such animation of movement of sound sources could be provided in the form of a program. User input means could be provided which allow a user to select a desired program from among a plurality of different programs.

In yet another example, the set point position may be determined based on localization information contained in the input audio data. For example, if the input audio data are stereophonic input audio data which contain at least left channel input data and right channel input data, the method may comprise decomposing the left channel input data to generate left channel decomposed data, decomposing the right channel input data to generate right channel decomposed data, and determining the set point position of the virtual sound source outputting the particular musical timbre relative to the position of the virtual listener based on the left channel decomposed data and the right channel decomposed data. Thus, in a simple embodiment, the set point position may depend on at least one of a time difference and/or an intensity difference between the left channel decomposed data and the right channel decomposed data. This allows setting the set point position of a virtual sound source to substantially correspond to the original position of that sound source in the original input audio data. Furthermore, reverberation may be detected in the input audio data or in the decomposed data and the set point position may be determined based on the amount of reverberation detected. This allows setting the set point position further away from the virtual listener for sound sources having a higher amount of reverberation.

In a further embodiment of the present invention, the method may include detecting at least one of a position, an orientation and a movement of a user by at least one sensor and determining the set point position relative to the virtual listener based on the detection result. It is thus possible to change the arrangement of the at least one virtual sound source in the virtual 3D space depending on a position, orientation and/or movement of the user in order to allow additional ways for the user to control the stereophonic image. In particular, the method may include detecting a movement of a user relative to an inertial frame by at least one sensor, and may further include determining the set point position relative to the user based on the detected movement, such that the set point position remains fixed relative to the inertial frame during the movement of the user. Fixing the set point position with respect to the inertial frame in which a user is moving allows for a very realistic three-dimensional illusion of distributed sound sources, for example instruments which are arranged at particular positions within the space. For example, a particular instrument can be fixed at a particular position within the inertial frame, such that a user may move within the inertial frame towards or away from that virtual instrument, while perceiving a very realistic sound as if the instrument was actually present at and fixed to the set point position.

The method may further take into account a movement of the loudspeakers such as headphones relative to the inertial frame, either by detecting the use of headphones (in which case the movement of the loudspeakers can be assumed to correspond to the movement of the user's head) or by additionally sensing the movement of the loudspeakers relative to the inertial frame. For example, if the user wears headphones and performs a rotation about 90° to the left, the set point position of the virtual sound source can deliberately be rotated relative to the virtual listener about 90° to the right such that the set point position effectively remains fixed to the inertial frame. As another example, if the set point position of a virtual sound source is at a center position 5 meters in front of the user (the virtual listener) and a movement of the user by 1 meter in the forward direction is detected through the sensor, the set point position relative to the virtual listener can be changed to a position 4 meters in front of the virtual listener, such that the set point position remains fixed with respect to the inertial frame. Such an embodiment will provide a very realistic sound experience to the user comparable to natural hearing of actually present sound sources.

Decomposing the input audio data may be carried out by an analysis of the frequency spectrum of the input audio data and identifying characteristic frequencies of certain sound sources, musical instruments or vocals, for example based on a Fourier-transformation of audio data obtained from the input audio data. In a preferred embodiment of the present invention, the step of decomposing the input audio data includes processing of audio data obtained from the input audio data within an artificial intelligence system (AI system), preferably containing a trained neural network. In particular, an AI system may implement a convolutional neural network (CNN), which has been trained by a plurality of data sets for example including a vocal track, a harmonic/instrumental track and a mix of the vocal track and the harmonic/instrumental track. Examples for conventional AI systems capable of separating source tracks such as a singing voice track from a mixed audio signal include: Pretet, “Singing Voice Separation: A study on training data”, Acoustics, Speech and Signal Processing (ICASSP), 2019, pages 506-510; “spleeter”—an open-source tool provided by the music streaming company Deezer based on the teaching of Pretet above, “PhonicMind” (https://phonicmind.com)—a voice and source separator based on deep neural networks, “Open-Unmix”—a music source separator based on deep neural networks in the frequency domain, or “Demucs” by Facebook AI Research—a music source separator based on deep neural networks in the waveform domain. These tools accept music files in standard formats (for example MP3, WAV, AIFF) and decompose the song to provide decomposed/separated tracks of the song, for example a vocal track, a bass track, a drum track, an accompaniment track or any mixture thereof.

In a further embodiment of the present invention, the input audio data are provided in the form of at least one input track formed by a plurality of audio frames, and wherein the step of decomposing the input audio data comprises decomposing a plurality of consecutive segments of the input track to provide segments of decomposed data, each input track segment having a length larger than the length of one of the audio frames. Decomposing the input audio data segment-wise allows obtaining at least parts of the results, i.e. segments of stereophonic output data, faster than in a case where the method would wait for the entire input track to be processed completely. Thus, decomposing the plurality of input track segments may obtain a plurality of segments of decomposed data, wherein generating the stereophonic output data may be based on the plurality of segments of decomposed data obtain a plurality segments of stereophonic output data, wherein a first segment of the plurality of segments of stereophonic output data may be obtained before a second segment of the input track segments is being decomposed. Therefore, the stereophonic output data may be obtained simultaneously to the processing of the input audio data, i.e. in parallel to the step of decomposing.

If the entire process from decomposing a segment of the input audio data to generating a segment of stereophonic output data is faster than the real time playback of a segment (of the same length), playback of stereophonic output data can be started and carried out without interruptions as soon as a first segment of the input track has been decomposed and transformed. More specifically, generating the stereophonic output data may include determining consecutive stereophonic output data segments based on the decomposed data segments and the determined set point position, while, at the same time, decomposing further input track segments, wherein a first of the consecutive stereophonic output data segments may be obtained within a time smaller than 5 second, preferably smaller than 200 milliseconds, after the start of decomposing an associated first segment of the input track segments. Fast processing or even real-time output (faster than playback speed) of the stereophonic output data allows do dynamically change the stereophonic arrangement of the sound sources, for example through user input or through an algorithm, during continuous playback of the stereophonic output data.

According to a second aspect of the present invention, the above-mentioned object is achieved by a device for processing audio data, comprising an input unit receiving input audio data containing a mixture of different timbres, a decomposition unit for decomposing the input audio data to generate decomposed data representing a predetermined timbre selected from the timbres contained in the input audio data, a set point determination unit for determining a set point position of a virtual sound source outputting the predetermined timbre relative to a position of a virtual listener, and a stereophonic audio unit for determining stereophonic output data based on the decomposed data and the determined set point position. The device of the second aspect achieves the same or corresponding effects and advantages as mentioned above for the method of the first aspect of the invention. In particular, the device allows creating or rearranging a stereophonic image, for example arranging or rearranging musical instruments or vocalists in the virtual 3D space.

The device preferably includes a spatial effect unit for applying a spatial effect processing to audio data obtained from the decomposed data, wherein a parameter of the spatial effect unit is set depending on the determined set point position, and/or a time shift processing unit for time shift processing of audio data obtained from the decomposed data, wherein the time shift is set depending on the determined set point position. Such a spatial effect processing or time shift processing unit may provide the most important cues fora listener to localize a sound source in the virtual space.

The device of the second aspect preferably comprises an input unit adapted to receive a user input allowing a user to set at least one of the position of the virtual listener and the set point position. Such input unit may be a user interface of a computer, such as a touchscreen of a tablet or smartphone, or a midi controller, for example.

In a further embodiment of the second invention, the stereophonic audio unit preferably includes a mixing unit for mixing first audio data obtained from the decomposed data with second audio data different from the first audio data, said second audio data preferably being second decomposed data obtained by decomposing the input audio data in the decomposition unit, wherein said second audio data represent a predetermined second timbre selected from the timbres contained in the input audio data. Therefore, the device in this embodiment may generate stereophonic output data which not only include one specific timbre, but may comprise additional timbres, in particular additional timbres of the original input audio data. In a preferred embodiment, all timbres of the original input audio data are again included in the stereophonic output data, wherein only the spatial arrangement of one or more of the virtual sound sources is changed.

The device of the second embodiment may comprise a display unit adapted to display at least a graphical representation indicating the position of the virtual listener within an inertial frame, and a further graphical representation indicating the set point position of the virtual sound source within the inertial frame. Therefore, a user may easily recognize a current relative positioning of a virtual sound source contained in the input audio data as well as its own position, i.e. the position of the virtual listener. Based on such graphical representation, a user may conveniently set a desired set point position of a virtual sound source relative to the virtual listener or relative to the inertial frame, or may set a desired set point position of the virtual listener relative to the virtual sound source(s) or relative to the inertial frame.

In another embodiment of the invention, the device may provide a user interface for allowing a user to select a preset from among a list of presets, said presets each including predetermined set point positions for each of a plurality of virtual sound sources and, optionally, individual spatial effect settings for individual sound sources, wherein generating the stereophonic output data is carried out based on the decomposed data as well as based on the predetermined set point positions of the selected preset and, optionally, the spatial effect settings. For example, such presets may include:
a concert hall preset, which includes different concert hall reverberations for different sound sources as spatial effect settings,
a percussions-in-the-back preset, which places the set point positions of decomposed data representing percussion timbres into the virtual background and setting spatial effect settings for those decomposed data which define a reverberation,
a singer-in-the-front preset, which places the set point positions of decomposed data representing vocal timbres into the virtual center and foreground,
a 4-corners preset, which places the set point positions of decomposed data representing four different timbres into the four corners of the virtual 3D space around the virtual listener.

The set point position may further be set based on localization information contained in the original input audio data. For example, the input unit may be adapted to receive stereophonic input audio data which contain at least left channel input data and right channel input data, wherein the decomposition unit may be adapted to decompose the left channel input data to generate left channel decomposed data, and to decompose the right channel input data to generate right channel decomposed data, and wherein the set point determination unit may be adapted to set the set point position of the virtual sound source outputting the particular timbre relative to the position of the virtual listener based on the left channel decomposed data and the right channel decomposed data.

For high-quality decomposition results and/or high-quality stereophonic output data, the method preferably further comprises a step of reducing localization information from the input audio data and/or from the decomposed data, wherein reducing localization information preferably includes at least one of (1) reducing or removing reverberation and (2) transforming stereophonic audio data to monophonic audio data. Any localization information is then newly introduced only during the step of generating stereophonic output data.

In a preferred embodiment of the present invention, the decomposition unit may include an artificial intelligence system (AI system) containing a neural network, in particular an artificial intelligence system as described above with respect to the method of the first aspect of the present invention.

Furthermore, the device of the second aspect of the present invention is preferably adapted to carry out a method as described above with respect to the first aspect of the present invention.

Moreover, in devices of the second aspect of the present invention, preferably at least the input unit, the decomposition unit, the set point determination unit and the stereophonic audio unit are preferably implemented by a software application running on a computer, preferably a personal computer, a tablet or a smartphone. This allows implementing the present invention using standard hardware.

According to a third aspect of the present invention, the above-mentioned object is achieved by a computer program configured to carry out, when run on a computer, preferably on a personal computer, a tablet or a smartphone, a method according to the first aspect of the present invention, and/or a computer program configured to operate a device according to the second aspect of the present invention.

Preferred embodiments of the present invention will now be explained in further detail with respect to the accompanying drawings, in which

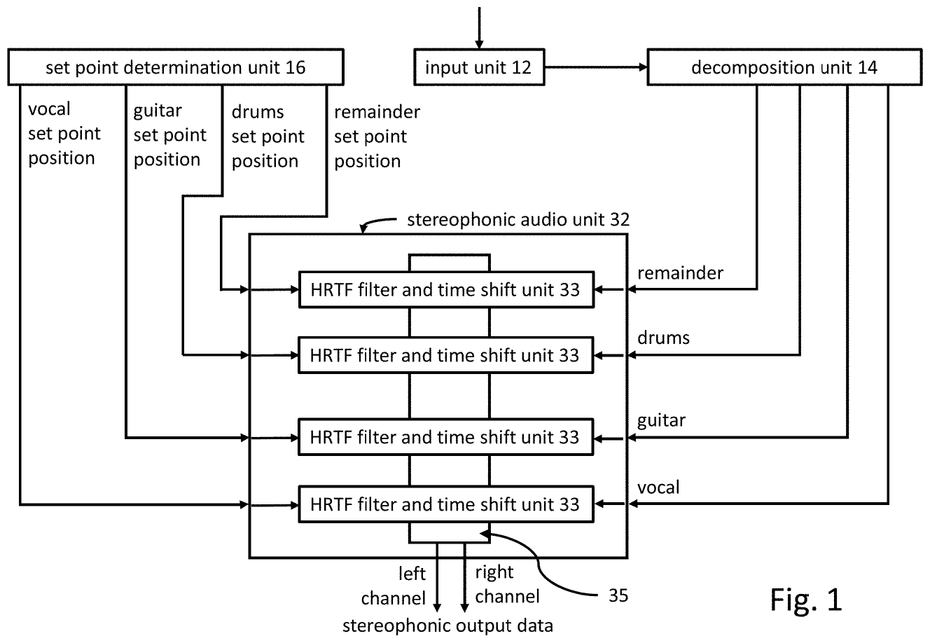

FIG. 1 shows a functional diagram illustrating components of a device for processing audio data according to a first embodiment of the present invention;

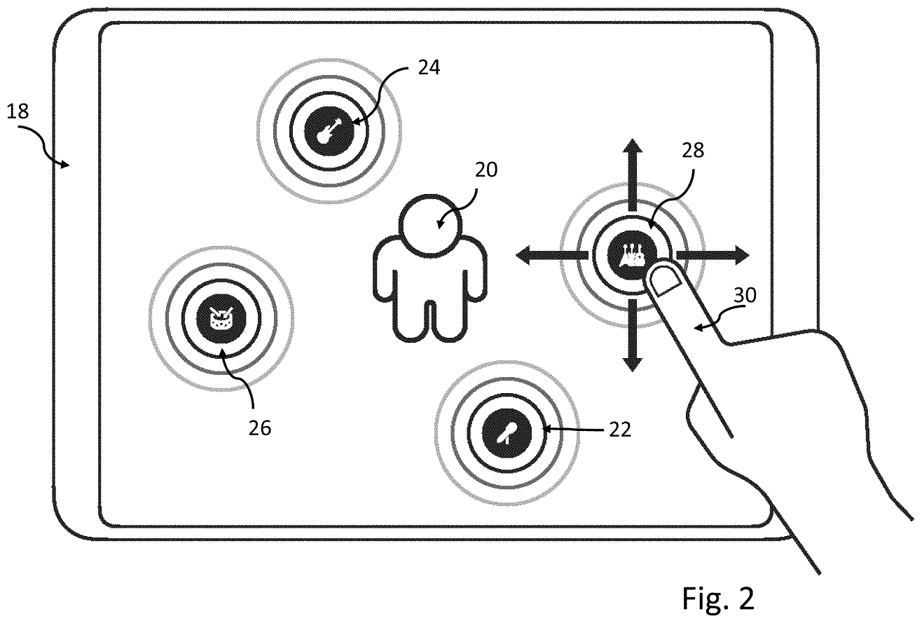

FIG. 2 shows a graphical display and user input device of the device of the first embodiment of the present invention; and

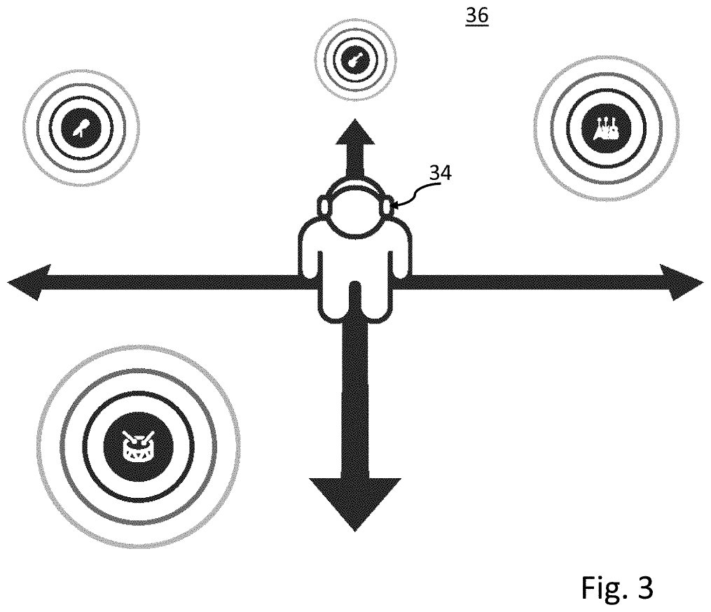

FIG. 3 shows a device for processing audio data according to a second embodiment of the present invention.

A device 10 according to the first embodiment of the present invention is illustrated in FIG. 1 by showing some of its important components, in particular an input unit 12 which is adapted to receive input audio data such as an audio file. In particular, input unit 12 may be adapted to allow a user to select and/or receive an audio file such as a desired piece of music provided by streaming via the Internet, by reading from a permanent storage or in any other manner conventionally known. Audio files may be received in compressed or decompressed format, in particular standard audio formats such as MP3, WAV, AIFF, etc.

Input audio data or audio data derived therefrom are then transferred to a decomposition unit 14, which includes an artificial intelligence system comprising a neural network that has been trained to decompose the audio data such as to separate at least one timbre component, for example at least one musical instrument, as decomposed data. Multiple neural networks trained to decompose different timbres may be provided, or alternatively one neural network trained to decompose audio data to obtain several different musical timbres may be implemented. In the present example, the decomposition unit 14 generates complimentary sets of decomposed data, namely different sets of decomposed data corresponding to different musical instruments contained in the input audio data, and a set of remainder decomposed data, which includes all other timbres and sounds not included in the former sets of decomposed data. More specifically, as a mere example, in FIG. 1, decomposition unit 14 generates decomposed vocal data, decomposed guitar data, decomposed drum data and remainder decomposed data, the latter including all timbres of the original input audio data, except the vocal timbre, the guitar timbre and the drum timbre.

Device 10 further includes a set point determination unit 16, which allows determination of a number of set point positions, in particular one set point position for each set of decomposed data. In the example of FIG. 1, a vocal set point position is determined that represents a desired position of the vocals in the virtual 3D space, a guitar set point position is determined which represents a desired position of the guitar in the virtual 3D space, a drum set point position is determined which represents a desired position of the drums in the virtual 3D space, and a remainder set point position is determined which represents a desired position of the remainder instruments and sound sources in the virtual 3D space.

The set point positions may be determined by set point determination unit 16 based on a user input received via a user interface. FIG. 2 shows an example for such user interface implemented by a touchscreen of a portable device 18, such as a tablet or smartphone running a suitable computer program. The display of the portable device 18 shows a graphical representation of the user 20, which corresponds to the virtual listener in the stereophonic space, and further shows graphical representations of the individual instruments, the timbres of which contribute to the sound of the input audio data, namely, in the present example, a vocal representation 22, a guitar representation 24, a drum representation 26 and a remainder representation 28. The positions of the graphical representations 20 to 28 reflect the current position of the virtual listener and the current set point positions associated to the individual sets of decomposed data, i.e. to the set point positions of the individual instruments or vocal components, respectively. Therefore, in the specific example shown in FIG. 2, in which a user's viewing direction is indicated by an arrow V, the set point positions are currently set in such a manner that the vocals are positioned in front and slightly left of the user 20, the guitars are positioned behind and slightly right of the user 20, the drums are positioned right and slightly in front of the user 20 and the remainder of the instruments are positioned on the left side of the user 20.

As can be seen in FIG. 2, by user operation, for example a touch gesture through a finger 30 of the user, the set point position of the virtual listener or any of the virtual sound sources can be defined or changed. For example, in FIG. 2, the set point position of the remainder instruments is manipulated by swiping the graphical representation 28 of the remainder instruments.

The set point positions as determined by the set point determination unit 16 as well as the decomposed data as generated by the decomposition unit 14 are introduced into a stereophonic audio unit 32. Stereophonic audio unit 32 may include a standard stereo imaging algorithm or any other means for generating stereophonic data based on audio data and a desired set point position of that audio data within the stereo image. For example, stereophonic audio unit 32 may use an OpenAL library, which allows defining a plurality of virtual sound sources positioned at specified coordinates within the virtual space, and which then generates stereophonic output data in a standard stereophonic audio format for output through a stereophonic two-channel or surround sound systems.

In the illustrated example, the stereophonic audio unit 32 uses HRTF filter units 33 for applying HRTF filtering to each of the sets of decomposed data (vocal, drums, guitar and remainder) according to the respective set point positions such as to generate stereophonic component data for each sound source. The stereophonic component data are then mixed in a mixing unit 35 to obtain stereophonic output data in a standard stereophonic audio format including left channel data and right channel data and optionally data for additional channels such as for surround sound.

FIG. 3 shows a second embodiment of the present invention, which is a modification of the first embodiment described above. Therefore, only the differences between the second embodiment and first embodiment will be described in more detail, and reference is made to the description of the first embodiment with regard to all other features and functions as described above.

The second embodiment differs from the first embodiment in the configuration of the set point determination unit 16, in particular in the configuration of the user interface used in or in connection with the set point determination unit 16. In particular, the user interface of the second embodiment includes a sensor 34 adapted to detect at least one of a position, an orientation and a movement of the user. The sensor 34 may for example be an acceleration sensor such as a 3-axis or 6-axis acceleration sensor conventionally known for detecting movement of objects and for obtaining position information of objects. Preferably, sensor 34 is attached to headphones worn by the user such that it can be integrated in a simple manner and can recognize movements of the user's head at the same time. Alternatively, sensor 34 may be attached to a wearable virtual reality system (VR system) or a smart watch etc.

Based on a given initial setting of the set point positions of the individual sound sources, which may for example be determined through user input via a user interface, such as the portable device 18 described for the first embodiment of the present invention, the set point positions of the virtual sound sources can now be changed based on a movement of the user as detected by detector 34. Thus, a movement of the user may initiate any kind of rearrangement of the virtual sound sources in the virtual space.

In a particular preferred example of the invention, the modification of the set point positions depending on the movement of the user can be performed in such a way that perceived positions of the virtual sound sources remain fixed with respect to an inertial frame 36 within which the user is moving. The inertial frame may for example be the room in which the user is moving or the ground on which the user is standing. In particular, the set point determination unit, in the second embodiment of the present invention, may modify all set point positions of all virtual sound sources relative to the user (virtual listener) upon a detected movement of the user, in such a way as to virtually reverse the detected movement. Since the set point positions are defined relative to the user (virtual listener), who is moving together with its headphones relative to the inertial frame, such a reverse movement of the set point positions relative to the user will result in the positions of the virtual sound sources remaining fixed with respect to the inertial frame 36.

To give an example, in the case illustrated in FIG. 3, the drums are located at an angle of 45° in front and to the right of the user. If the user turns clockwise to the right by 45°, such as to directly face towards the virtual position in the inertial frame 36 from which the user is perceiving the sound of the drums, according to the present embodiment of the invention, the set point position of the drums relative to the user is rotated 45° in counter-clockwise direction, such that it appears on a central forward position relative to the virtual listener in the virtual space. As a result, the user will obtain the impression of directly facing the drums, which means that the drums have virtually maintained in a fixed position with respect to the inertial frame 36.

As a result, the user will obtain a realistic impression of several musical instruments and vocalists present at particular positions in a space, such as if they were actually present.

1. Method for processing audio data, comprising
providing input audio data containing a mixture of different timbres,
decomposing the input audio data to generate decomposed data representing a predetermined timbre selected from the timbres contained in the input audio data,
determining a set point position of a virtual sound source outputting the predetermined timbre relative to a position of a virtual listener,
generating stereophonic output data based on the decomposed data and the determined set point position.

2. Method of claim 1, wherein determining stereophonic output data includes spatial effect processing of audio data obtained from the decomposed data, wherein a parameter of the spatial effect processing is set depending on the determined set point position, and/or applying a time shift processing to audio data obtained from the decomposed data, wherein the time shift is set depending on the determined set point position.

3. Method of claim 1 or claim 2, wherein the stereophonic output data containing at least left channel output data adapted to be played by a left loudspeaker, and right channel output data adapted to be played by a right loudspeaker, wherein the left channel output data include left channel component data obtained from the decomposed data and the right channel output data include right channel component data obtained from the decomposed data, and wherein a time difference and/or an intensity difference between the left channel component data and the right channel component data is based on the set point position of the virtual sound source relative to the virtual listener.

4. Method of at least one of claims 1 to 3, further comprising a step of reducing localization information from the input audio data and/or from the decomposed data, wherein reducing localization information preferably includes at least one of (1) reducing or removing reverberation and (2) transforming stereophonic audio data to monophonic audio data.

5. Method of at least one of the preceding claims, wherein determining stereophonic output data includes mixing of first audio data obtained from the decomposed data with second audio data different from the first audio data, said second audio data preferably being second decomposed data obtained by decomposing the input audio data, wherein said second audio data represent a specified second timbre selected from the timbres contained in the input audio data.

6. Method of at least one of the preceding claims, wherein the set point position of the virtual sound source relative to the virtual listener is determined based on user input.

7. Method of at least one of the preceding claims, wherein the input audio data are stereophonic input data which contain at least left channel input data and right channel input data, and wherein the method comprises:
decomposing the left channel input data to generate left channel decomposed data,
decomposing the right channel input data to generate right channel decomposed data,
determining the set point position of the virtual sound source outputting the predetermined timbre relative to the position of the virtual listener based on the left channel decomposed data and the right channel decomposed data.

8. Method of at least one of the preceding claims, further including detecting at least one of a position, an orientation and a movement of a user by at least one sensor and determining the set point position based on the detection result.

9. Method of at least one of the preceding claims, further including detecting a movement of a user relative to an inertial frame by at least one sensor, and determining the set point position relative to the virtual listener based on the detected movement, such that the set point position remains fixed relative to the inertial frame during the movement of the user.

10. Method of at least one of the preceding claims, wherein decomposing the input audio data includes processing the input audio data by an artificial intelligence system (AI system) containing a neural network.

11. Method of at least one of the preceding claims, wherein the input audio data are provided in the form of at least one input track formed by a plurality of audio frames, and wherein the step of decomposing the input audio data comprises decomposing a plurality of consecutive segments of the input track to provide segments of decomposed data, each input track segment having a length larger than the length of one of the audio frames.

12. Method of claim 11, wherein generating the stereophonic output data includes determining consecutive stereophonic output data segments based on the decomposed data segments and the determined set point position, while, at the same time, decomposing further input track segments, wherein a first of the consecutive stereophonic output data segments is obtained within a time smaller than 5 second, preferably smaller than 200 milliseconds, after the start of decomposing an associated first segment of the input track segments.

13. Device for processing audio data, comprising
an input unit receiving input audio data containing a mixture of timbres,
a decomposition unit for decomposing the input audio data to generate decomposed data representing a predetermined timbre selected from the timbres contained in the input audio data,
a set point determination unit for determining a set point position of a virtual sound source outputting the predetermined timbre relative to a position of a virtual listener, and
a stereophonic audio unit for generating stereophonic output data based on the decomposed data and the determined set point position.

14. Device of claim 13, wherein the stereophonic audio unit includes a spatial effect unit for applying a spatial effect processing to audio data obtained from the decomposed data, wherein a parameter of the spatial effect unit is set depending on the determined set point position; and/or a time shift processing unit for time shift processing of audio data obtained from the decomposed data, wherein the time shift is set depending on the determined set point position.

15. Device of claim 13 or claim 14, comprising an input unit adapted to receive a user input allowing a user to set at least one of the position of the virtual listener and the set point position.

16. Device of at least one of claims 14 to 15, wherein the stereophonic audio unit includes a mixing unit for mixing first audio data obtained from the decomposed data with second audio data different from the first audio data, said second audio data preferably being second decomposed data obtained by decomposing the input audio data in the decomposition unit, wherein said second audio data represent a specified second timbre selected from the timbres contained in the input audio data.

17. Device of at least one of claims 13 to 16, comprising a display unit adapted to display at least a graphical representation indicating at least one of a position, an orientation and a movement of the virtual user within an inertial frame, and a further graphical representation indicating the set point position of the virtual sound source within the inertial frame.

18. Device of at least one of claims 13 to 17, wherein the input unit is adapted to receive stereophonic input audio data which contain at least left channel input data and right channel input data, wherein the decomposition unit is adapted to decompose the left channel input data to generate left channel decomposed data, and to decompose the right channel input data to generate right channel decomposed data, and wherein the set point determination unit is adapted to set the set point position of the virtual sound source outputting the specified musical timbre relative to the position of the virtual listener based on the left channel decomposed data and the right channel decomposed data.

19. Device of at least one of claims 13 to 18, further including at least one sensor for detecting at least one of a position, an orientation and a movement of a user, wherein the set point determination unit is adapted to determine the set point position based on a detection result of the sensor.

20. Device of at least one of claims 13 to 19, further including at least one sensor for detecting a movement of a user relative to an inertial frame, wherein the set point determination unit is adapted to determine the set point position relative to the virtual listener based on the detected movement, such that the set point position remains fixed relative to the inertial frame during the movement of the user.

21. Device of at least one of claims 13 to 20, wherein the decomposition unit includes an artificial intelligence system (AI system) containing a neural network.

22. Device of at least one of claims 13 to 21, adapted to carry out a method according to any of claims 1 to 12.

23. Device of at least one of claims 13 to 22, wherein at least the input unit, the decomposition unit, the set point determination unit and the stereophonic audio unit are implemented by a software application running on a computer, preferably a personal computer, a tablet or a smartphone.

24. Computer program configured to carry out, when running on a computer, preferably on a personal computer, a tablet or a smartphone, a method according to any of claims 1 to 12, and/or configured to operate a device according any of claims 13 to 23.
